(19) United States
(12) Patent Application Publication
(10) Pub. No.: US 2026/0065289 A1
(43) Pub. Date: Mar. 5, 2026

(54) CARBON FOOTPRINT ESTIMATOR USING CROP EMISSION PHENOLOGY

(71) Applicant: INTERNATIONAL BUSINESS MACHINES CORPORATION, Armonk, NY (US)

(72) Inventors: Kamal Chandra Das, New Delhi (IN); Devyani Lambhate, Bangalore (IN); Ayush Jain, Lucknow (IN); Manikandan Padmanaban, Chennai (IN); Jagabondhu Hazra, Bangalore (IN); Hendrik F. Hamann, Bedford, NY (US)

(21) Appl. No.: 18/817,901

(22) Filed: Aug. 28, 2024

(51) Int. Cl. G06Q 30/018; G06Q 50/02

(52) U.S. Cl. CPC G06Q 30/018; G06Q 50/02

(57) ABSTRACT

A computer-implemented method for emission estimation includes collecting top down information including above surface information related to land and collecting bottom up information including below surface information related to the land. Greenhouse gas emissions are estimated for specific parcels of land based in accordance with a parcel size of a first granularity for the top down information and the bottom up information. A geospatial foundation model is fine-tuned using a physics informed loss function that accounts for estimated CO₂ through remote sensing and weather and phenological information from soil data, wherein the fine-tuning creates a hyper local model that allocates emissions at a second granularity that has a higher spatial resolution than the first granularity.

### BACKGROUND

The present invention generally relates to generative artificial intelligence (AI) systems and, more particularly, to systems and methods for estimating a carbon footprint based on crop development at a granular level using remote sensing and crop phenology.

The agriculture sector accounts for a large portion (e.g., 15%-18%) of global greenhouse gas (GHG) emissions. Annual emissions are used to derive emission factors at the national level which are utilized for estimating localized emissions. However, this approach does not provide accurate agricultural emissions at a granular level and does not provide adequate insights for reducing the emissions.

### SUMMARY

In accordance with an embodiment of the present invention, a computer-implemented method for emission estimation includes collecting top down information including above surface information related to land and collecting bottom up information including below surface information related to the land. Greenhouse gas emissions are estimated for specific parcels of land based in accordance with a parcel size of a first granularity for the top down information and the bottom up information. A geospatial foundation model is fine-tuned using a physics-informed loss function that accounts for estimated CO₂ through remote sensing and weather and phenological information from soil data, wherein the fine-tuning creates a hyper local model that allocates emissions at a second granularity that has a higher spatial resolution than the first granularity.

In accordance with another embodiment of the present invention, an emission estimation system includes a hardware processor and a memory that stores a computer program which, when executed by the hardware processor, causes the hardware processor to collect top down information including above surface information related to land and collect bottom up information including below surface information related to the land. Greenhouse gas emissions are estimated for specific parcels of land based in accordance with a parcel size of a first granularity for the top down information and the bottom up information. A geospatial foundation model is fine-tuned using a physics-informed loss function that accounts for estimated CO₂ by remote sensing and weather and phenological information from soil data, wherein the fine-tuning creates a hyper local model that allocates emissions at a second granularity that has a higher spatial resolution than the first granularity.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram of a system for estimating hyper local greenhouse gas emissions, in accordance with an embodiment of the present invention;

FIG. 2 is a block diagram of showing a process based model (e.g., a denitrification-decomposition (DNDC) model) employed in bottom up gas emissions determinations, in accordance with an embodiment of the present invention;

FIG. 3 is a diagram showing combining trace gases into an equivalent CO₂ gas emission value for fine-tuning a geo-spatial model, in accordance with an embodiment of the present invention;

FIG. 4 is a block/flow diagram showing a fine-tuning layer and process for fine-tuning a geo-spatial model, in accordance with an embodiment of the present invention;

FIG. 5 is a block/flow diagram showing training of three subtasks for the fine-tuning, in accordance with an embodiment of the present invention;

FIG. 6 is a block/flow diagram showing aspects of a physical-informed loss function employed in training/fine-tuning the geo-spatial foundation model, in accordance with an embodiment of the present invention;

FIG. 7 is a block/flow diagram showing a system/method for determining gas emissions from a crop at a hyper local resolution, in accordance with an embodiment of the present invention;

FIG. 8 is a block/flow diagram showing a system/method for emissions estimation using a crop phenology fine-tuned geo-spatial foundation model for a hyper local resolution, in accordance with an embodiment of the present invention; and

FIG. 9 is a flow diagram showing methods for determining gas emissions from a crop at a hyper local resolution, in accordance with an embodiment of the present invention.

### DETAILED DESCRIPTION

In accordance with embodiments of the present invention, carbon footprints of agricultural products are estimated at a granular level for a plurality of crops by leveraging remote sensing and crop phenology using a geo-spatial foundation model. CO₂ emissions from agricultural fields exhibit a natural process of co-existence with other greenhouse gas (GHG) trace gases such as NOₓ, methane, etc. and the extent of the CO₂ emissions can be determined by a phenological and biological condition of vegetation, soil, weather, and other factors. In an embodiment, a top down approach is employed to estimate absolute CO₂ emissions using traces of CH₄, SO₂, CO, XCO₂, NO₂ and other gases as observations as a proxy of GHG. A bottom up approach includes crop emission phenological processes that are estimated using process based models for a considered crop type, soil, weather condition, etc.

In an embodiment, a system is trained by employing a fine-tuned IBM® geo-spatial foundation model (GFM) with a modified loss function accounting for crop emission phenology of CO₂ with other GHG trace gases, capturing the nitrous oxide (N₂O) emissions from nitrification and de-nitrification processes, and CH₄ emissions from fermentation processes at each defined crop growth stage to estimate a hyper local CO₂ footprint (per area) for a region of interest. Emissions are allocated to each crop in a hyper local resolution (e.g., disaggregation) based on a carbon intensity ratio of each crop available in a life cycle assessment (LCA) database. The combination of top down and bottom up approaches increases a spatio-temporal resolution of crop emission, e.g., from country level to county level or beyond.

In an embodiment, a system is provided that uses a combination of farm geolocations, weather information, remote sensing traces of coarse emissions such as, e.g., column-averaged carbon dioxide in the atmosphere (XCO₂), methane (CH₄), NOx, etc., (top down sources), and reported and historical yield from mandi agricultural market arrival and other entities (bottom up sources). The system learns the crop stagewise phenological emission process for a considered crop type, soil conditions and weather along the growth cycle, capturing the quantitative nitrous oxide (N₂O) emissions from nitrification and de-nitrification processes, and CH₄ emissions from fermentation processes at each defined crop growth stage. The system further incorporates derived emission phenological processes as physical constraints dynamically considering the crop growth stages to fine-tune a physics-informed geospatial foundation model for hyperlocal estimation of crop-wise GHG emission.

In another embodiment, methods leverage derived crop phenological emission processes to fine-tune the physics-informed geospatial foundation model for hyper local estimation of GHG emissions. The methods provide an emission allocation methodology to disaggregate the estimated coarse GHG emission to hyper local crop-wise GHG emissions.

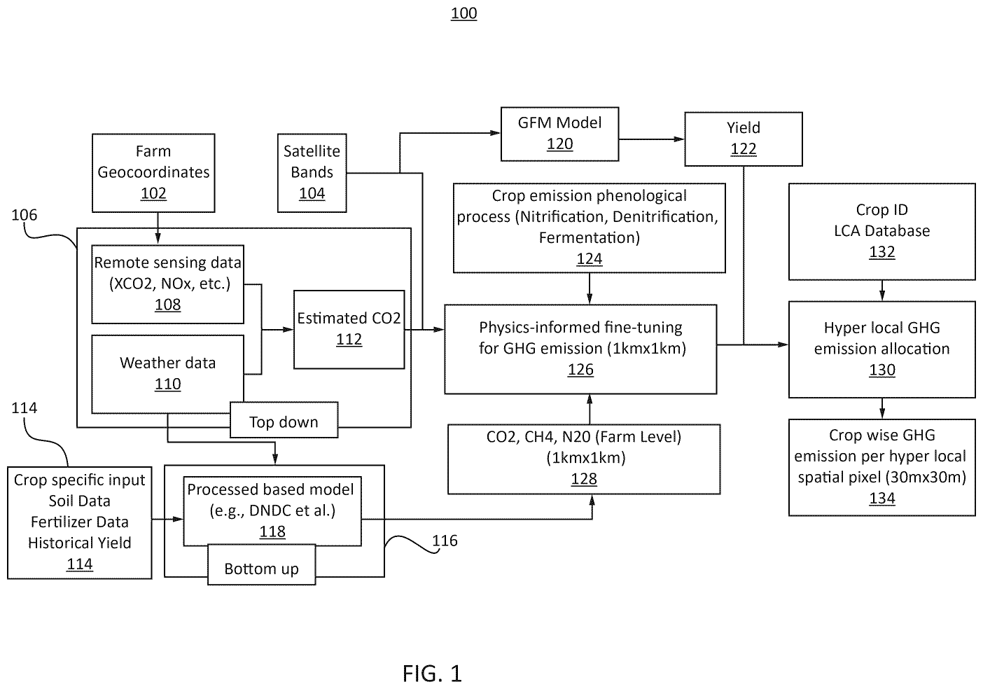

Referring now to the drawings in which like numerals represent the same or similar elements and initially to FIG. 1, a carbon footprint estimation system 100 includes a combination of inputs that include top down information sources 106 and bottom up information sources 116. The top down information sources 106 and the bottom up information sources 116 are derived from data measured over time at particular locations to enable a granular estimation of carbon emissions for a specific location under the agricultural conditions that the location has or will experience. The top down information sources 106 are related to air quality, whether and atmospheric conditions, while the bottom up information sources 116 are related to soil conditions, chemical processes and earth topology.

Illustrative examples of the top down information sources 106 can include farm geolocations, weather information, remote sensing traces of coarse emissions such as, e.g., column-averaged carbon dioxide in the atmosphere (XCO₂), methane (CH₄), NOx, etc. Illustrative examples of the bottom up information sources 116 can include process based models, reported and historical yield data from mandi agricultural market arrival and other entities, soil conditions, etc. The system 100 learns crop stagewise phenological emission processes for a considered crop type, soil conditions and weather along a crop's growth cycle, capturing the quantitative nitrous oxide (N₂O) emissions from nitrification and de-nitrification processes, and CH₄ emissions from fermentation processes at each defined crop growth stage. The system 100 further incorporates derived emission phenological processes as physical constraints dynamically considering the crop growth stages to fine-tune a physics-informed geospatial foundation model for hyperlocal estimation of crop-wise GHG emission.

A bottom up approach includes crop emission phenological processes that are estimated using process based models for a considered crop type, soil, weather condition, etc. Crop specific inputs 114 can include crop type, soil data, burn information, fertilizer data, historical land-specific crop yields and other crop specific information. The crop specific inputs 114 are provided to a process based model 118, e.g., a denitrification-decomposition (DNDC) model, agricultural production systems simulator (APSIM), world food studies simulation model (WOFOST), decision support system for agrotechnology transfer (DSSAT), etc. The processed based model 118 can estimate gas emissions including GHG emissions from crops due to natural and artificial conditions. The process based model 118 uses the crop specific inputs 114 and inputs from the top down information sources 106 to compute gas emissions 128.

The top down information sources 106 can begin with geo-coordinates 102 for a given location, e.g., a farm. A remote sensing device or devices 108 are employed to gather data at the site of the geo-coordinates 102. The remote sensing device or devices 108 can gather measurements at the geo-coordinates 102. The measurements can include gas densities, e.g., XCO₂, N₂O, etc., temperature, humidity, gas intensities, measured rainfall, solar radiation and any other data measured be local sensors. The top-down information sources 106 gather weather data, historic and real-time, and with the measurements of the remote sensing device or devices 108 can provide an estimate in block 112 of CO₂ present at the geo-location. In an embodiment, an absolute CO₂ emission can be obtained based on relationships with other gases. For example, using traces of CH₄, SO₂, CO, XCO₂, NO₂ and other gases as observations as a fingerprint for total GHG or from CO₂ emissions in particular. An AI system trained on relationships between gases can be employed to predict the CO₂ emissions based on one or more other gases (trace gases) and their concentrations. The gas emissions 128 can include emissions for, e.g., CO₂, CH₄, N₂O, etc. The gas emissions 128 can be computed at farmland levels, e.g., an area of a square kilometer, although other sized land plots can be employed.

In block 104, data for weather conditions, air quality, stratospheric conditions, air movements, vapor content and other conditions can be obtained from one or more satellites and can be obtained at a plurality of satellite spectral bands. Each spectral band can include useful information about the soil, land use, etc. The satellite bands can include, e.g., blue, green, red, vegetation red edge, narrow near infrared (NIR), short wave IR 1 and short wave IR 2 for multi-spectral satellites, and for hyper-spectral satellites, there are approximately 200 such bands. Satellite data can be collected and used to supplement the remote sensing data collected by devices 108 and block 110. The satellite data employed can include historic data for a past time window and/or current satellite data from a contemporaneous satellite source.

A geo-spatial foundation model (GFM) 120, such as an IBM® GFM, can be employed to determine or predict CO₂ emissions for specific geographical locations. The GFM 120 uses satellite information from block 104 and estimated CO₂ emissions from block 112 to output a predicted crop yield for a crop or crops in question in block 122. These same inputs (e.g., from block 104 and block 112) are also input to a fine-tuning process 126 to fine-tune the GFM 120 for hyper local GHG emission estimations.

The fine-tuning process 126 includes a physics-informed fine-tuning for GHG emissions by estimating gas emission for given conditions based upon a life cycle of a particular crop. The fine-tuning process 126 receives as input phenological process information from block 124 for a crop's life cycle. The phenological process information can be centered around GHG emissions; however, other phenological processes can also be employed. In an embodiment, nitrification, denitrification and fermentation processes can be modeled using learned functions using data measurements to independently represent phenological processes that contribute to GHG emissions. In an example, fermentation can be represented independently of nitrification/denitrification.

In an embodiment, the fine-tuning process 126 employs data from gas emissions 128 for GHG, e.g., CO₂, CH₄, N₂O from the bottom up sources 116. While other gases may also be employed, these gases are incorporated into the fine-tuning process 126 to optimize hyper local predictions (e.g., higher resolution than the square km range (smaller pixels)).

Fine-tuning of the GFM 120 permits allocations of GHG emissions on a hyper local scale in block 130. The fine-tuning changes the parameters of the underlying GFM 120 to guide the GFM 120 to generate output that is optimized. The GFM 120 is an artificial intelligence (AI) model that is pretrained on data, e.g., from across the internet and other public resources. The GFM 120 in accordance with embodiments of the present invention is guided and refined to achieve a capability of estimating GHG on a hyper local scale. The fine-tuning employs a plurality of GHG gases to more accurately estimate GHG emissions at a higher granularity. By deploying the fine-tuned GFM 120, long-term inference costs are reduced and computational resources are saved. The fine-tuned GFM 120 can be employed to predict GHG emission for specific parcels of land instantly or over a duration of time.

The output of the fine-tuning process 126 is associated with actual crops, their yields (from block 122) and their lifecycles to be able to provide an estimate of GHG emissions over time. In an embodiment, a Life Cycle Assessment (LCA) database can be employed to identify a crop as input in block 132. The LCA database can include GHG emissions for a particular crop type for all stages, e.g., from production, processing, packaging, distribution, sale and consumption, with a CO₂-equivalent produced for each phase of the supply chain. Then, using the hyper local emission allocations in block 130 a crop wise GHG emission estimate can be made for the identified crop for a spatial pixel. The spatial pixel can represent a land area of, e.g., 30 meter by 30 meters. Higher resolutions are also contemplated.

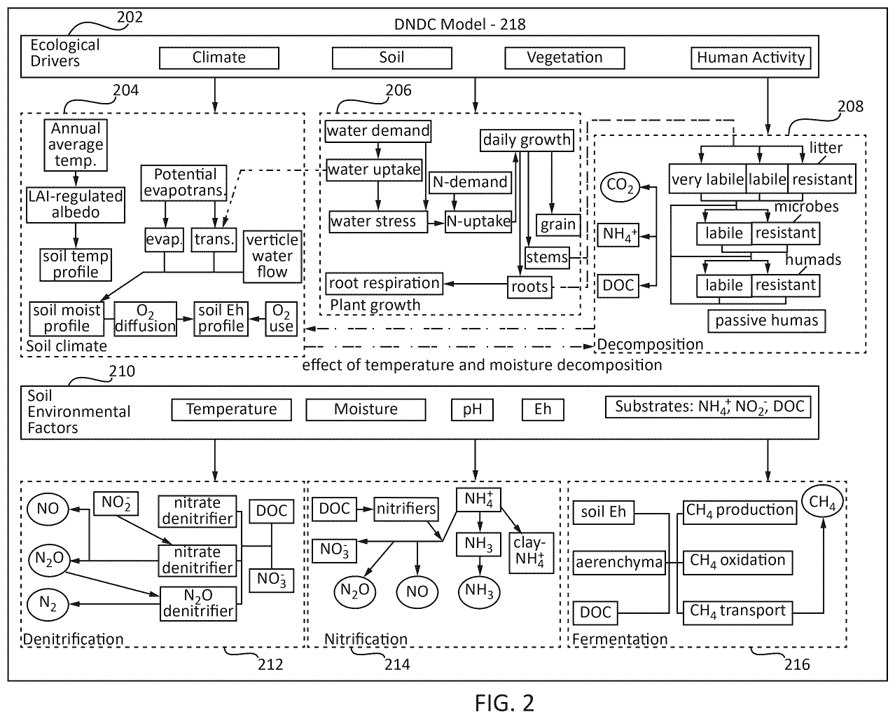

Referring to FIG. 2, in an example of a process based model (118 in FIG. 1), a DNDC model 218 is illustratively shown for a bottom up information resource in accordance with an embodiment. The DNDC model 218 provides information about the soil and vegetation at a particular location. The DNDC model 218 considers ecological drivers 202 that can affect particular crops or crop sites. For example, the ecological drivers 202 can include climate, soil conditions, other vegetation, human activity, etc. The ecological drivers 202 affect soil climate 204, plant growth 206 and decompositions processes 208, which, in turn, can affect soil environmental factors 210. The soil environmental factors 210 can include temperature, moisture, pH electronic activity (Eh), substrates including ammonium ions (NH₄⁺), nitrate ions (NO₃⁻) and dissolved organic carbon (DOC). The soil environmental factors 210 affect denitrification, nitrification and fermentation, which are bottom up sources of GHG emissions.

It should be understood that in addition to or instead of the DNDC model 218, other process based models can be employed, for example, APSIM, WOFOST, DSSAT, or others. Combinations of these and other models can also be employed.

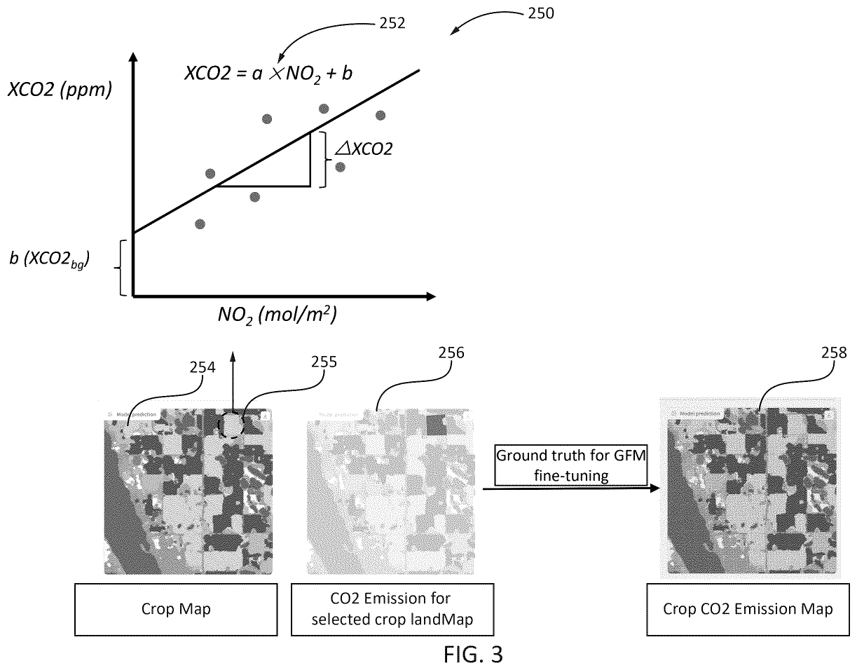

Referring to FIG. 3, estimated CO₂ emissions in block 112 (FIG. 1) can be computed as a function of other trace gases. For example, XCO₂=ƒ(NO, CO, SO₂, NO2, CH₄ . . . ), where ƒ=type of crop, soil type, stage of crop, biophysical plus phenological relations of crops versus trace gases. In an example, a plot 250 of XCO₂ versus NO₂ shows a relationship for a crop pixel 255 in a crop map 254 from winter until harvest. A flux estimate of CO₂ emissions in a map 256 can be employed as ground truth for GFM fine-tuning. Slopes of the trace gases can be determined by a linear regression analysis to compute the equation of a line for each relationship between CO₂ and the trace gas. Then, all slopes are aggregated with other trace gases to convert the other gases into CO₂ flux (kg/pixel), e.g., all trace gases are converted to an equivalent CO₂ emission. A mass balance approach (chemical balance) can be employed to provide such relationships. Then, in a next step for generalization, the GFM 120 will be fine-tuned to get CO₂ flux maps 258 for all crop pixels in question.

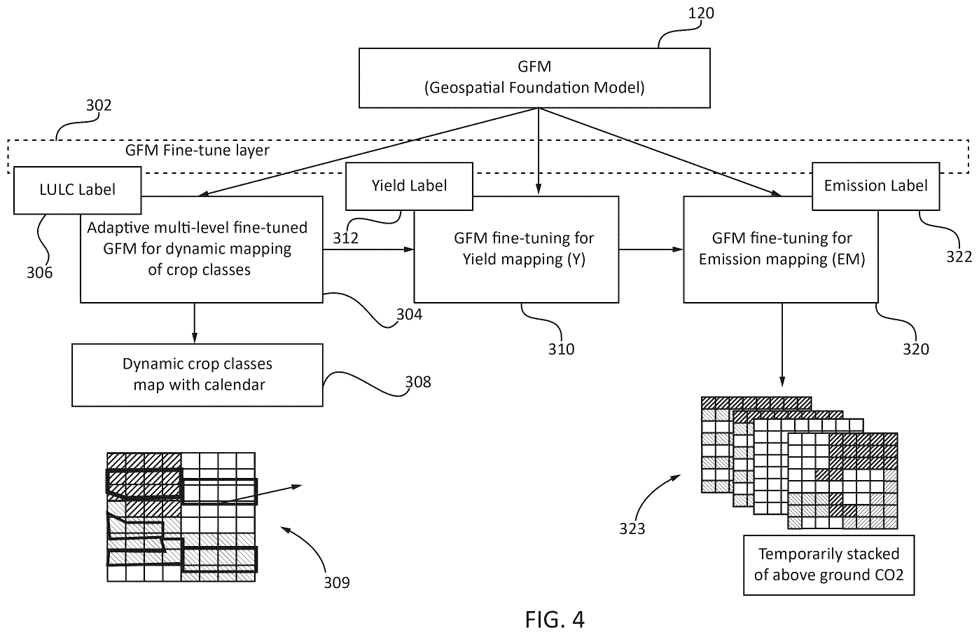

Referring to FIG. 4, a deep learning neural network of the GFM 120 is modified by including a GFM fine-tune layer 302. The GFM fine-tune layer 302 can be included using the fine-tuning process 126 of FIG. 1, which can be separated into a number of subtasks. In an embodiment, the subtasks can include training on dynamic crop maps (block 304), yield maps (block 310) and emission maps (block 320). Other subtasks and map categories are also contemplated.

In block 304, the GFM fine-tune layer 302 leverages an adaptive multi-level fine-tuned GFM to dynamically map crop classes by labeling data (e.g., maps or satellite images) with Land Use Land Cover (LULC) labels 306 to train the GFM 120 to enable dynamic crop classification with over different timeframes (e.g., crop changes over time). An output format of block 310 can include dynamic crop classes depicted with or within a calendar 309 to show changes over time.

The GFM fine-tune layer 302 is trained to map crop yields for yield mapping by labeling data (e.g., maps or satellite images) with yield labels 312. In block 320, the GFM fine-tune layer 302 is trained for emission mapping by labeling data (e.g., maps or satellite images) with emission labels 322. An output format can include temporal maps 323 stacked to show emission data or over time.

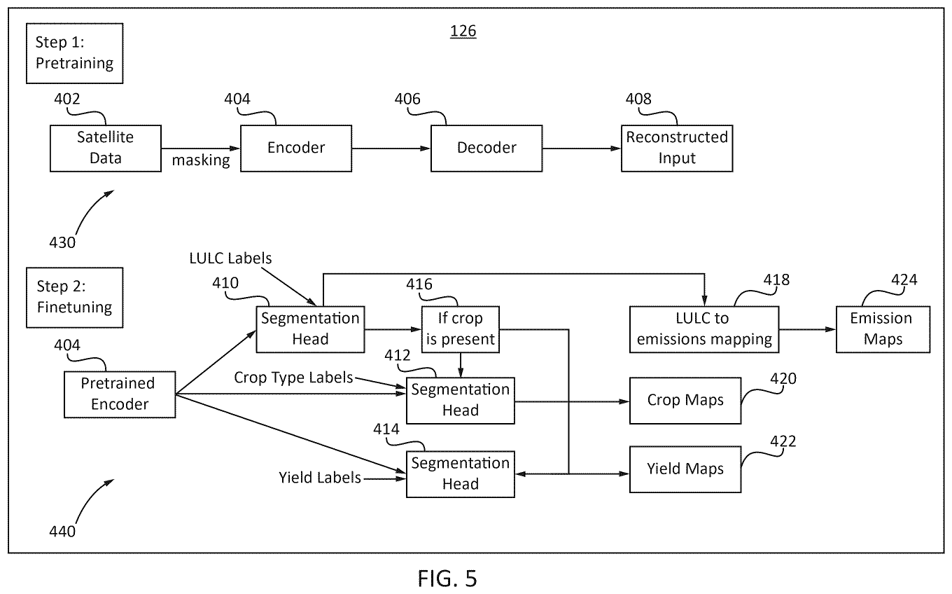

Referring to FIG. 5, the fine-tuning process 126 can include training the GFM 120 to optimize performance and to provide hyper local information for a number of useful applications. The subtasks in blocks 304, 310 and 320 can employ, e.g., a Prithvi model training technique to fine-tune the GFM 120.

Prithvi models include a vision transformer (ViT) pre-trained on satellite images 402. The satellite images 402 can be masked to focus on areas of interest/importance. The Prithvi model adopts a self-supervised encoder developed with a ViT architecture and a Masked AutoEncoder (MAE) learning strategy, with a most significant error (MSE) loss function. The Prithvi model includes spatial attention across multiple patches in a satellite image and also temporal attention for each patch. The ViT achieves remarkable results while obtaining substantially fewer computational resources for pre-training. The ViT model represents an input image (satellite image 402) as a series of image patches, and directly predicts class labels for the patches of the satellite image 402.

The ViT model accepts remote sensing data in a video format (e.g., B,C,T,H,W where B=batch size, C=number of channels, T=number of frames, H=height of image, W=width of image). Note that the temporal dimension (T) is included. The ability to handle a time series of remote sensing images can provide many useful applications (e.g., dynamic crop maps). The VIT also can be employed for static imagery which can be fed into the model with time T set equal to a constant (e.g., T=1).

In a pre-training stage 430, an encoder 404 positionally encodes the patches of the satellite images. A decoder 406 decodes the encoded image patches. A reconstructed image 408 is generated for the input image (402) or target image. A loss function is computed as feedback to compare the reconstructed image 408 to the target image 402 to adjust the weights of the encoder 404 until a mean squared error (MSE) loss function is optimized.

In a fine-tuning stage 440, the encoder 404 with the pretrained weights encodes training data at segmentation heads 410, 412, 414 which segment images into portions or patches and labels them, e.g., with LULC labels, crop type labels and yield labels, respectively. The fine-tuning stage 440 is a Multi-Head Self Attention Layer (MSP) in a neural network This MSP layer concatenates all the attention outputs linearly to the right dimensions. The many attention heads 410, 412, 414 help train local and global dependencies in an image. A Multi-Layer Perceptrons (MLP) Layer can be provided that contains a two-layer Gaussian Error Linear Unit (GELU). A Layer Norm (LN) can be included before each block to limit any new dependencies between the training images. This improves the training time and overall performance.

The MLP layer implements a classification head. It can do it with one hidden layer at pre-training time and a single linear layer for fine-tuning. The self-attention of MSP of the transformer architecture captures long-range dependencies and contextual information in the input data. The MSP allows the ViT model to attend to different regions of the input data, based on their relevance to the task. Therefore, the self-attention computes a weighted sum of the input data, where the weights are computed based on the similarity between the input features. This allows the trained model to give more importance to the relevant input features, which helps it capture more informative representations of the input data. The self-attention is quantified in pairwise entity interactions to assist the neural network in learning a hierarchy and alignment present inside input data.

The fine-tuning stage 440 can be focused on land that includes crops. In an embodiment, block 416 includes a mechanism to determine whether image data includes a crop. If present, the segmentation heads 412 and 414 are enabled. Otherwise, segmentation heads 412 and 414 will not output crop maps 420 and yield maps 422, respectively. If however, crops are present, fine-tuning progresses with output of crop maps 420 and yield maps 422 to accordingly train the GFM model. LULC emission mapping in block 418 is provided regardless as to whether crops are detected or not. Emission maps 424 are provided to accordingly train the GFM model. The training outputs in maps 420, 422, 424 employ a physics-informed loss function as will be described.

Artificial Machine learning systems can be used to predict outcomes based on input data, e.g., emission based on top down and bottom up environmental data. In an example, given a set of input data, a machine learning system can predict an outcome. The machine learning system will likely have been trained on much training data in order to generate its model. It will then predict the outcome based on the model.

In some embodiments, the artificial machine learning system includes an artificial neural network (ANN). One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

The present embodiments may take any appropriate form, including any number of layers and any pattern or patterns of connections therebetween. ANNs demonstrate an ability to derive meaning from complicated or imprecise data and can be used to extract patterns and detect trends that are too complex to be detected by humans or other computer-based systems. The structure of a neural network is known generally to have input neurons that provide information to one or more “hidden” neurons. Connections between the input neurons and hidden neurons are weighted, and these weighted inputs are then processed by the hidden neurons according to some function in the hidden neurons. There can be any number of layers of hidden neurons, and as well as neurons that perform different functions. There exist different neural network structures as well, such as a ViT, convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. A set of output neurons accepts and processes weighted input from the last set of hidden neurons.

This represents a “feed-forward” computation, where information propagates from input neurons to the output neurons. Upon completion of a feed-forward computation, the output is compared to a desired output available from training data. The error relative to the training data is then processed in “backpropagation” computation, where the hidden neurons and input neurons receive information regarding the error propagating backward from the output neurons. Once the backward error propagation has been completed, weight updates are performed, with the weighted connections being updated to account for the received error. It should be noted that the three modes of operation, feed forward, back propagation, and weight update, do not overlap with one another. This represents just one variety of ANN computation, and that any appropriate form of computation may be used instead. In the present case the output neurons provide emission information for a given plot of land provided from the input of satellite or other image data.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output or target. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set or target, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, the weights may be implemented as resistive processing units (RPUs), generating a predictable current output when an input voltage is applied in accordance with a settable resistance.

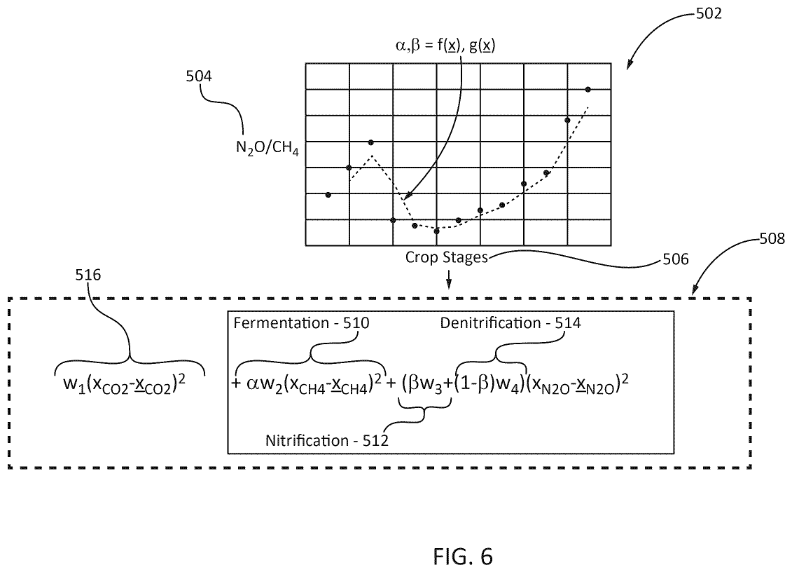

Referring to FIG. 6, a physics-informed loss function 508 is employed to provide fine-tuning training for the GFM in accordance with embodiments of the present invention. The physics-informed loss function 508 includes learnt functions that represent crop specific processes that result in GHG emissions. In an embodiment, a function f and a function g are learnt functions to represent crop specific fermentation and mutually exclusive nitrification and denitrification. For example, ƒ, g=func (type of crop, soil type, stage of crop, biophysical plus a phenological relation of the crop, etc.). Each function incorporates specifics that contribute to the processes in question.

The functions ƒ and g can be derived from measured data, measured data over time or other emissions related information. For example, the data can be specific for a given location or can be generic for a given crop type. In an embodiment, the gas concentration 504 can be plotted over crop stages 506 or time. A graphical representation 502 can be employed to derive a plot from which an equation or equations can be derived. The physics-informed loss function 508 includes components to the emissions gases that are pertinent, in this case, CO₂, CH₄, N₂O, which are important GHG. Coefficients α and β can be obtained mathematically from the graphical representation 502. Weights w₁, w₂, w₃ and w₄ are updated through training to optimize error. A term 516 is a squared difference between CO₂ concentrations. A fermentation process term 510 is a squared difference between CH₄ concentrations. A nitrification term 512 is a portion of a squared difference between concentrations of N₂O, and a denitrification term 514 is a portion of the squared difference between concentrations of N₂O.

The physics-informed loss function 508 guides training since random relationships are not solely relied upon. In so doing, not only is training reduced, but model accuracy is increased thereby improving performance by making hyper local predictions guided by physical relationships. It should be understood that the physics-informed loss function 508 can take on other forms. For example, additional terms can be added or substituted, other relationships can be included in the equation, additional weights can be added, other natural phenomena can be included, etc.

A neural network becomes trained by exposure to empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

A deep neural network, such as a multilayer perceptron, can have an input layer of source nodes, one or more computation layer(s) having one or more computation nodes, and an output layer, where there is a single output node for each possible category into which the input example could be classified. An input layer can have a number of source nodes equal to the number of data values in the input data. The computation nodes in the computation layer(s) can also be referred to as hidden layers, because they are between the source nodes and output node(s) and are not directly observed. Each node in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

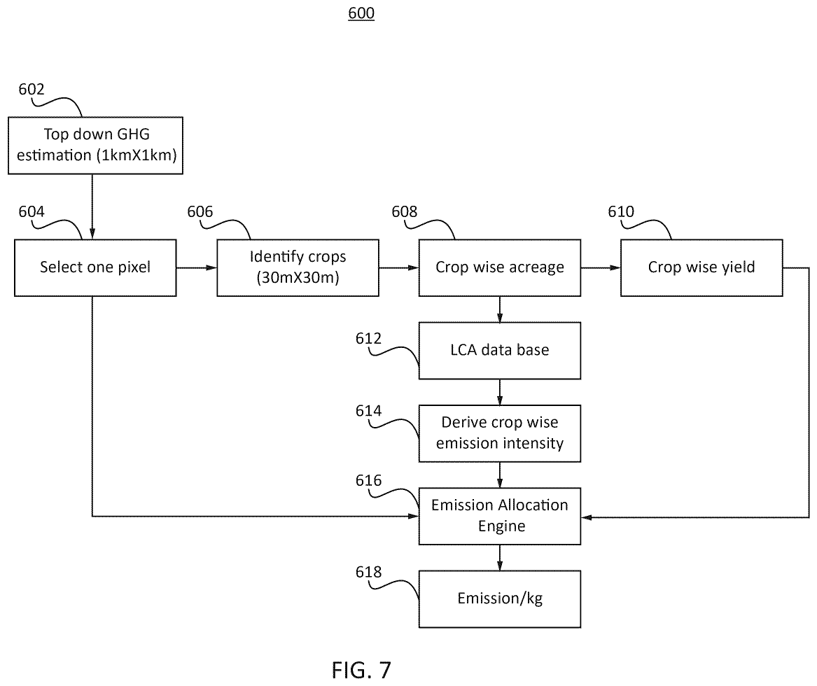

Referring to FIG. 7, a method for employing a crop phenology-inspired fine-tuned GFM is shown in accordance with embodiments of the present invention is described. A computer program product embodiment “CPP”) can be employed to estimate gas emissions. An estimate of gas emissions is needed for a plot of land. In block 602, a top down view is consulted for an estimate of emissions. The top down view provides a granularity of a square km but further granularity is needed. In block 604, a pixel in an area of interest on a map (e.g., satellite image or digitally rendered map) is selected. The pixel represents the square km where the emissions estimate is desired. In block 606, within the pixel, crops are identified with a 30 m by 30 m granularity although other spatial resolutions are contemplated. In block 608, crop wise acreage is computed within the pixel. In block 610, a crop wise yield can be estimated in accordance with the crop wise acreage.

In block 612, an LCA database or other database or source can be consulted to determine the emissions for a particular crop within the region of interest. Using the LCA database or other source, a crop wise emission intensity is derived in block 614.

Emission intensity: x is the absolute emission of a pixel p; then, xᵢⱼ denotes a sub-pixel at position (i,j) such that

$$x = {\sum }_{i = 1}^{m} {\sum }_{j = 1}^{n} {x}_{i j} .$$

Assume there are 1, 2, . . . , n crops in pixel p:
a₁, a₂, . . . aₙ, are acreages of each crop; y₁, y₂, . . . yₙ, are yields of each crop and l₁, l₂, . . . lₙ, are emission intensities of each crop.

Let c be a scale factor. Then:

$${l}_{1} * c 1 * {y}_{1} + {l}_{2} * c 2 * {y}_{2} + … + {l}_{n} * c n * {y}_{n} = x$$

Variable c can be determined from the above equation and emission for crop

$$i = {l}_{i} * \frac{c i}{{y}_{i}}$$

where cᵢ=ƒ (weather, soil properties).

In block 616, an emission allocation engine computes emissions for the selected pixel using emission intensities and crop yields. The emission estimate employs the GFM fine-tuned with the physics-informed loss function 508 and both top down and bottom up informational sources.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums can include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

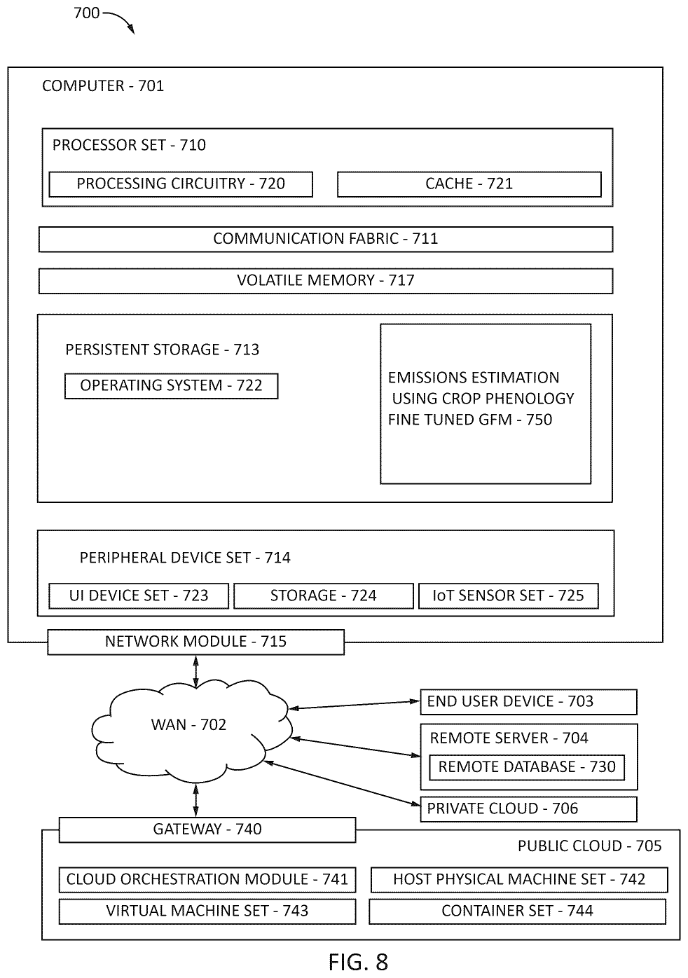

Referring now to FIG. 8, a block diagram of a computing environment is shown. Computing environment 700 contains an example of an environment for the execution of at least some of the computer code involved in performing the inventive methods, such as emission estimation using crop phenology in a fine-tuned geospatial foundation model (GFM) 750. In addition to block 750, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 750, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible.

Computer 701 may be located in a cloud, even though it is not shown in a cloud in FIG. 7. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 750 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in block 750 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices.

Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

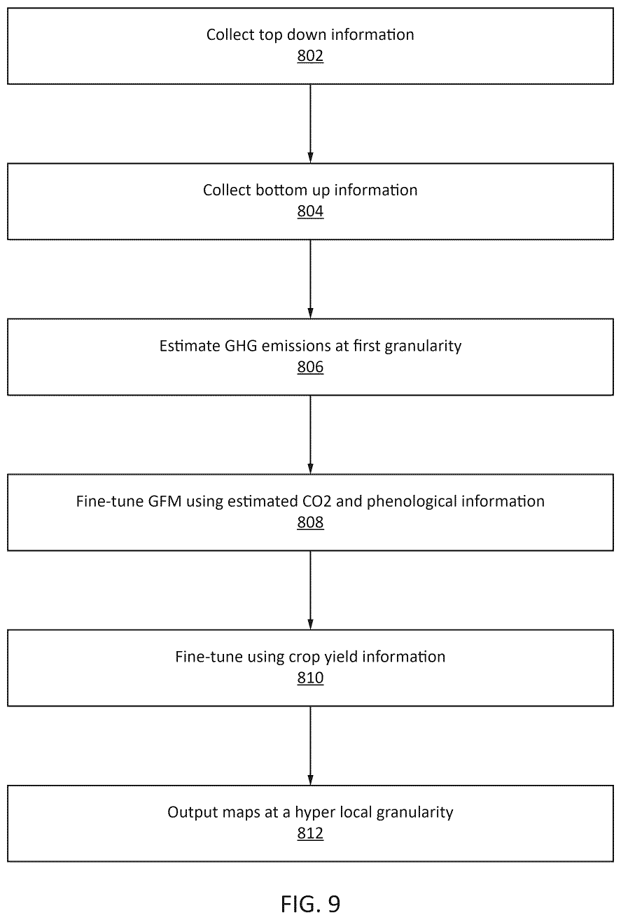

Referring to FIG. 9, computer-implemented methods for emission estimation are described in accordance with embodiments of the present invention. In block 802, top down information is collected including above surface information related to land. This include remote sensing data (e.g., satellite data), weather data and other atmospheric data/conditions including greenhouse gas concentrations from remote sensors or parameters related to a given parcel, e.g., farm.

In block 804, bottom up information is collected including below surface information related to the land. This can include soil conditions, other vegetation, and other land conditions or parameters related to a given parcel, e.g., farm. Soil data can be determined using process based models, e.g., a denitrification-decomposition (DNDC) model and/or other process based models to estimate gas concentrations.

In block 806, greenhouse gas emissions are estimated for specific parcels of land based in accordance with a parcel size of a first granularity using the top down information and the bottom up information. In block 808, a geo-spatial foundation model is fine-tuned using a physics informed loss function that accounts for estimated CO₂ by remote sensing and weather and phenological information from soil data, wherein the fine-tuning creates a hyper local model that allocates emissions at a second granularity that is less than the first granularity. The first granularity can include a square km and the second granularity can include a higher spatial resolution (smaller pixel size) than the first granularity. For example, the second granularity can include an area of less than 30 square meters. The physics-informed loss function can include a term for each gas. In an embodiment, the physics-informed loss function can include carbon emissions, a term for fermentation, a term for nitrification and a term for denitrification.

In block 810, the land can include farmland a crop yield data can be determined for the farmland using the geospatial foundation model. The crop yield data can be employed in the hyper local model to allocate emissions at the second granularity.

In block 812, the fine-tuned geospatial foundation model can output dynamic crop maps, yield maps and emission maps at the second granularity. Other output maps are also contemplated.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments for systems and methods (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for emission estimation, comprising:
collecting top down information including above surface information related to land;
collecting bottom up information including below surface information related to the land;
estimating greenhouse gas emissions for specific parcels of land based in accordance with a parcel size of a first granularity for the top down information and the bottom up information;
fine-tuning a geospatial foundation model using a physics informed loss function that accounts for estimated CO₂ by remote sensing, and weather and phenological information from soil data from the greenhouse gas emissions estimate of the first granularity, wherein the fine-tuning creates a hyper local model that allocates emissions at a second granularity that has a higher spatial resolution than the first granularity.

2. The method of claim 1, wherein collecting top down information includes obtaining atmospheric data including greenhouse gas concentrations from remote sensors.

3. The method of claim 1, wherein collecting bottom up information includes using soil data and a denitrification-decomposition (DNDC) model to estimate gas concentrations.

4. The method of claim 1, wherein the second granularity includes an area of less than 30 square meters.

5. The method of claim 1, wherein the land includes farmland and further comprising determining crop yield data for the farmland using the geospatial foundation model.

6. The method of claim 5, further comprising employing the crop yield data in the hyper local model to allocate emissions at the second granularity.

7. The method of claim 1, wherein physics informed loss function includes a term for carbon emissions, a term for fermentation, a term for nitrification and a term for denitrification.

8. The method of claim 1, wherein fine-tuning the geospatial foundation model includes fine-tuning the geospatial foundation model to output dynamic crop maps, yield maps and emission maps at the second granularity.

9. A computer program product for deploying a system, the computer program product comprising a computer readable storage medium having program instructions embodied therewith, the program instructions executable by a hardware processor to cause the hardware processor to:
collect top down information including above surface information related to land;
collect bottom up information including below surface information related to the land;
estimate greenhouse gas emissions for specific parcels of land based in accordance with a parcel size of a first granularity for the top down information and the bottom up information; and
fine-tune a geospatial foundation model using a physics informed loss function that accounts for estimated CO₂ by remote sensing, and weather and phenological information from soil data from the greenhouse gas emissions estimate of the first granularity, wherein the fine-tune creates a hyper local model that allocates emissions at a second granularity that has a higher spatial resolution than the first granularity.

10. The computer program product of claim 9, wherein the program instructions executable by the hardware processor cause the hardware processor to obtain atmospheric data from remote sensors and soil data for use with a denitrification-decomposition (DNDC) model to estimate gas concentrations.

11. The computer program product of claim 9, wherein the second granularity includes an area of less than 30 square meters.

12. The computer program product of claim 9, wherein the land includes farmland and the program instructions executable by the hardware processor cause the hardware processor to determine crop yield data for the farmland using the geospatial foundation model, wherein the crop yield data is employed in the hyper local model to allocate emissions at the second granularity.

13. The computer program product of claim 9, wherein the physics informed loss function includes a term for carbon emissions, a term for fermentation, a term for nitrification and a term for denitrification.

14. The computer program product of claim 9, wherein the program instructions executable by the hardware processor causes the hardware processor to fine-tune the geospatial foundation model to output dynamic crop maps, yield maps and emission maps at the second granularity.

15. An emission estimation system, comprising:
a hardware processor; and
a memory that stores a computer program which, when executed by the hardware processor, causes the hardware processor to:
collect top down information including above surface information related to land;
collect bottom up information including below surface information related to the land;
estimate greenhouse gas emissions for specific parcels of land based in accordance with a parcel size of a first granularity for the top down information and the bottom up information; and
fine-tune a geospatial foundation model using a physics informed loss function that accounts for estimated CO₂ by remote sensing, and weather and phenological information from soil data from the greenhouse gas emissions estimate of the first granularity, wherein the fine-tune creates a hyper local model that allocates emissions at a second granularity that has a higher spatial resolution than the first granularity.

16. The system of claim 15, wherein the computer program causes the hardware processor to obtain atmospheric data from remote sensors, soil data for use with a denitrification-decomposition (DNDC) model to estimate gas concentrations.

17. The system of claim 15, wherein the second granularity includes an area of less than 30 square meters.

18. The system of claim 15, wherein the land includes farmland and the computer program causes the hardware processor to determine crop yield data for the farmland using the geospatial foundation model, wherein the crop yield data is employed in the hyper local model to allocate emissions at the second granularity.

19. The system of claim 15, wherein the physics informed loss function includes a term for carbon emissions, a term for fermentation, a term for nitrification and a term for denitrification.

20. The system of claim 15, wherein the computer program causes the hardware processor to fine-tune the geospatial foundation model to output dynamic crop maps, yield maps and emission maps at the second granularity.
